(19) United States
(12) Patent Application Publication
(10) Pub. No.: US 2023/0260042 A1
(43) Pub. Date: Aug. 17, 2023

(54) INFORMATION CONTROL APPARATUS, SYSTEM, METHOD, AND NON-TRANSITORY COMPUTER READABLE MEDIUM STORING PROGRAM

(71) Applicant: NEC Corporation, Minato-ku, Tokyo (JP)

(72) Inventor: Nobuaki Kawase, Tokyo (JP)

(73) Assignee: NEC Corporation, Minato-ku, Tokyo (JP)

(21) Appl. No.: 18/011,628

(22) PCT Filed: Jun. 24, 2020
(86) PCT No.: PCT/JP2020/024703

§ 371 Date: Dec. 20, 2022

(51) Int. Cl. G06Q 40/08; G06V 40/16

(52) U.S. Cl. CPC G06Q 40/08; G06V 40/172

(57) ABSTRACT

An information control apparatus (10) includes image data acquisition means (110), authentication control means (111), insurance information acquisition means (112), output means (113), certificate information acquisition means (114), and application means (115). The image data acquisition means (110) acquires image data including a face image of a user. The authentication control means (111) causes an authentication apparatus that stores face feature information of the user to perform facial authentication. The insurance information acquisition means (112) acquires, when the facial authentication has been successful, insurance information related to the facial authentication from a storage apparatus that stores insurance information regarding medical insurance. The output means (113) outputs insurance information to a predetermined terminal apparatus that corresponds to an image-capturing apparatus. The certificate information acquisition means (114) acquires, from a medical institution, certificate information of medical treatment that the user has received as a response to the output. The application means (115) transmits, when the certificate information has been acquired from the medical institution, certificate information to an insurance provider with which the user has a contract.

### TECHNICAL FIELD

The present invention relates to an information control apparatus, a system, a method, and a program.

### BACKGROUND ART

Various kinds of systems that deal with medical information have been developed.

In a system disclosed in Patent Literature 1, for example, when non-prescription medical services or products are purchased by a method such as electronic money transaction, a facial recognition system is utilized for verification of the subject's identity, request, or receipt of the product or service requested.

In a medical information system disclosed in Patent Literature 2, a medical institution information processing apparatus requires authentication of a patient and a doctor and a home information processing apparatus requires authentication of the patient. Biometric information for identity authentication used here is, for example, biometric identification data for performing authentication by fingerprints. This literature discloses that the biometric information for identity authentication may include, besides the aforementioned data, the patient's face image.

### CITATION LIST

### Patent Literature

[Patent Literature 1] International Patent Publication No. WO 2015/073375
[Patent Literature 2] Japanese Unexamined Patent Application Publication No. 2011-28330

### SUMMARY OF INVENTION

### Technical Problem

A patient who has received medical treatment in a medical institution pays a medical fee for the medical treatment he/she has received and receives an insurance money from a medical insurance provider with which the patient has a contract. It is assumed that these series of procedures are taken by the patient himself/herself. However, these series of procedures are often complicated. Further, if, for example, a patient is receiving medical treatment for a sudden accident, illness, or the like in a medical institution but does not have an insurance card as he/she was not carrying it at the time the sudden accident, illness, or the like occurred, the burden on the patient of taking the above procedures increases. Also, if the language this patient speaks is different from the language spoken by staff members or the like in the medical institution, it is difficult to take the procedures for obtaining the medical insurance.

The present disclosure has been made in order to solve the aforementioned problem, and an object of the present disclosure is to provide an information control apparatus, a system, a method, and a program that reduce the burden of taking procedures regarding medical insurance.

### Solution to Problem

An information control apparatus according to one example embodiment of the present disclosure includes image data acquisition means, authentication control means, user identification information acquisition means, output means, and application means. The image data acquisition means acquires image data including a face image of a user captured by a predetermined image-capturing apparatus. The authentication control means causes an authentication apparatus that stores face feature information of the user to perform facial authentication for image data. The insurance information acquisition means acquires, when the facial authentication has been successful, insurance information related to the facial authentication from a storage apparatus that stores insurance information regarding medical insurance that the user has purchased. The output means outputs the insurance information to a predetermined terminal apparatus that corresponds to the image-capturing apparatus. The certificate information acquisition means acquires, from a medical institution, certificate information of medical treatment that the user has received as a response to the above output. The application means transmits, when the certificate information has been acquired from the medical institution, certificate information to an insurance provider with which the user has a contract.

In an information control method according to one example embodiment of the present disclosure, a computer performs the following steps. The computer acquires image data including a face image of a user captured by a predetermined image-capturing apparatus. The computer causes an authentication apparatus that stores face feature information of the user to perform facial authentication for the image data. The computer acquires, when the facial authentication has been successful, the insurance information related to the facial authentication from a storage apparatus that stores insurance information regarding medical insurance that the user has purchased. The computer outputs the insurance information to a predetermined terminal apparatus that corresponds to the image-capturing apparatus. The computer acquires, from a medical institution, certificate information of medical treatment that the user has received as a response to the output. The computer transmits, when the certificate information has been acquired from the medical institution, the certificate information to an insurance provider with which the user has a contract.

A program according to one example embodiment of the present disclosure causes a computer to execute the following steps. The computer acquires image data including a face image of a user captured by a predetermined image-capturing apparatus. The computer causes an authentication apparatus that stores face feature information of the user to perform facial authentication for the image data. The computer acquires, when the facial authentication has been successful, the insurance information related to the facial authentication from a storage apparatus that stores insurance information regarding medical insurance that the user has purchased. The computer outputs the insurance information to a predetermined terminal apparatus that corresponds to the image-capturing apparatus. The computer acquires, from a medical institution, certificate information of medical treatment that the user has received as a response to the output. The computer transmits, when the certificate information has been acquired from the medical institution, the certificate information to the insurance provider with which the user has a contract.

### Advantageous Effects of Invention

According to the present disclosure, it is possible to provide an information control apparatus, a system, a method, and a program that reduce the burden of taking procedures regarding medical insurance.

### BRIEF DESCRIPTION OF DRAWINGS

FIG. 1 is a block diagram showing a configuration of an information control apparatus according to a first example embodiment;

FIG. 2 is a flowchart showing an information control method according to the first example embodiment;

FIG. 3 is a block diagram showing a configuration of an information control apparatus according to a second example embodiment;

FIG. 4 is a flowchart showing an information control method according to the second example embodiment;

FIG. 5 is a block diagram showing a configuration of an information control apparatus according to a third example embodiment;

FIG. 6 is a flowchart showing an information control method according to the third example embodiment;

FIG. 7 is a block diagram showing a configuration of an information control system according to a fourth example embodiment;

FIG. 8 is a block diagram showing a configuration of an authentication apparatus;

FIG. 9 is a flowchart showing a flow of face feature information registration processing;

FIG. 10 is a flowchart showing a flow of facial authentication processing;

FIG. 11 is a block diagram showing a configuration of a facial authentication unit;

FIG. 12 is a block diagram showing a configuration of a user terminal;

FIG. 13 is a block diagram showing a configuration of an information control apparatus;

FIG. 14 is a diagram showing an example of a display of a terminal apparatus;

FIG. 15 is a diagram showing an example of a display of a user terminal;

FIG. 16 is a diagram showing an example of an insurance money benefit application screen; and

FIG. 17 is a diagram showing an example of a display when medical expenses are settled.

### EXAMPLE EMBODIMENT

In the following description, with reference to the drawings, example embodiments of the present disclosure will be described in detail. Throughout the drawings, the same or corresponding components are denoted by the same reference symbols and overlapping descriptions will be omitted as necessary for the sake of clarification of the description.

### First Example Embodiment

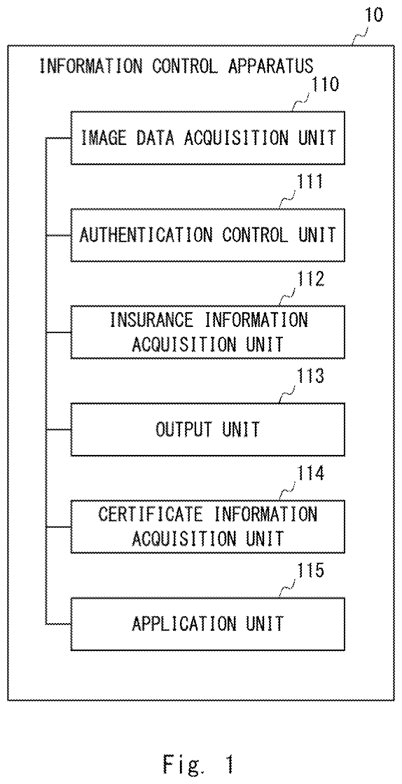

Referring to FIG. 1, a configuration of an information control apparatus will be described. FIG. 1 is a block diagram showing a configuration of an information control apparatus 10 according to a first example embodiment. The information control apparatus 10 performs facial authentication for a user such as a patient who uses a medical institution such as a clinic or a hospital, and thus processes at least a part of procedures regarding medical insurance of the user. The information control apparatus 10 is connected to a communication network (hereinafter the communication network will also be simply referred to as a network) and performs various kinds of communication with an external apparatus via the connected network.

Specifically, the information control apparatus 10 is connected to an image-capturing apparatus, an authentication apparatus, a storage apparatus, a terminal apparatus, and an insurance agency terminal via the network. The image-capturing apparatus shoots the user's face and supplies image data of the captured image to the information control apparatus 10. The authentication apparatus receives the image data from the information control apparatus 10 and performs facial authentication related to the received image data. The storage apparatus stores information regarding medical insurance purchased by the user (i.e., insurance information) and provides the insurance information of the user related to the facial authentication for the information control apparatus 10. The terminal apparatus receives the insurance information of the user related to the facial authentication from the information control apparatus 10 and displays the received insurance information. Further, the terminal apparatus supplies the certificate information regarding the medical treatment that the user related to the facial authentication has received to the information control apparatus 10. The insurance agency terminal, which is a terminal managed by an insurance provider or an insurance agency which manages the medical insurance, receives the certificate information provided from the information control apparatus 10. The network may either be a wired network or a wireless network. Further, any type of communication protocol may be used. The information control apparatus 10 mainly includes an image data acquisition unit 110, an authentication control unit 111, an insurance information acquisition unit 112, an output unit 113, a certificate information acquisition unit 114, and an application unit 115.

The image data acquisition unit 110 acquires the image data including the face image of the user captured by a predetermined image-capturing apparatus. The authentication control unit 111 causes the authentication apparatus that stores face feature information of the user to perform facial authentication on the image data.

The insurance information acquisition unit 112 acquires, when the facial authentication has been successful, the insurance information related to the facial authentication from the storage apparatus that stores the insurance information regarding the medical insurance that the user has purchased. The insurance information, which is information regarding medical insurance purchased by the user, includes information regarding the contract that the user has made with the medical insurance institution when he/she purchases the medical insurance. More specifically, the insurance information includes information regarding at least one of the name of the insurance agency or the insurance provider which manages the medical insurance purchased by the user, the type of the medical insurance, the medical treatment covered by the medical insurance, and unique identification information on the user in the medical insurance. The unique identification information on the user in the medical insurance, which is information for identifying the contract made between the user and the medical insurance institution, is called, for example, a contract number, a policy number or the like. The insurance information may include profile information such as the name, sex, nationality and the like of the user. The insurance information may include user's contact information (telephone number, email address, social network service account, etc.)

The output unit 113 outputs the insurance information to a predetermined terminal apparatus that corresponds to the image-capturing apparatus. Cases in which the predetermined terminal apparatus corresponds to the image-capturing apparatus include, for example, a case in which the image-capturing apparatus and the terminal apparatus are provided in the same facility, a case in which the administrator who manages the image-capturing apparatus is the same as the administrator who manages the terminal apparatus, or a case in which the administrator who manages the image-capturing apparatus and the administrator who manages the terminal apparatus perform a predetermined operation in collaboration with each other. The image-capturing apparatus may be a part of the terminal apparatus. The terminal apparatus may be a part of the image-capturing apparatus.

The place where the image-capturing apparatus or the terminal apparatus is provided is, for example, a medical institution. The information control apparatus 10 outputs the insurance information of the user whose face image has been captured in a medical institution to the terminal apparatus of the medical institution. Then, the terminal apparatus presents the insurance information of the user for a medical staff member, whereby the information control apparatus 10 is able to support the treatment that the medical staff member performs for the user.

When the user performs facial authentication in the medical institution, the image-capturing apparatus managed by a medical institution and a mobile terminal of the user who receives medical treatment in the medical institution correspond to each other. Therefore, the image-capturing apparatus may be managed by the medical institution and the terminal apparatus may be a mobile terminal that the user has. In this case, the user may present the insurance information output to the mobile terminal of the user to the medical institution.

The certificate information acquisition unit 114 acquires, from the medical institution, as a response to the above output by the output unit 113, certificate information of the medical treatment that the user has had. More specifically, the certificate information acquisition unit 114 acquires, for example, the certificate information from a terminal apparatus installed in a medical institution. The certificate information is information for certifying that a medical institution has performed medical treatment for a user related to the facial authentication. The certificate information includes, for example, medical institution identification information for identifying the medical institution, a medical certificate related to the medical treatment, and identification information on the user. The identification information on the user may be included in the insurance information of the user. Since the certificate information includes these information items, the certificate information is information in which the user is associated with the medical treatment that the user has received.

The application unit 115 transmits, when the information control apparatus 10 has acquired the certificate information from the medical institution, certificate information to the insurance provider with which the user has a contract. The information control apparatus 10 transmits, after the certificate information acquisition unit 114 has acquired the certificate information, the acquired certificate information to an insurance agency terminal managed by the insurance agency.

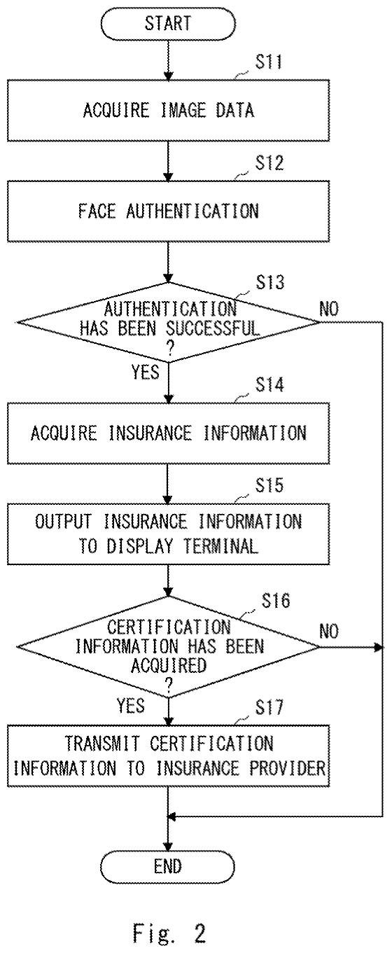

Referring next to FIG. 2, processing performed by the information control apparatus 10 will be described. FIG. 2 is a flowchart showing an information control method performed by the information control apparatus 10 according to the first example embodiment.

First, the information control apparatus 10 acquires image data from the image-capturing apparatus via a network (Step S11). In this case, the information control apparatus 10 may request the image-capturing apparatus to transmit the image data or may receive the image data transmitted from the image-capturing apparatus for each predetermined period.

Next, the information control apparatus 10 causes the authentication apparatus to perform the facial authentication (Step S12). More specifically, the information control apparatus 10 supplies the image data received from the image-capturing apparatus to the authentication apparatus and requests the authentication apparatus to perform authentication. The authentication apparatus stores identification information of a plurality of users in association with face feature information of the plurality of users. The authentication apparatus extracts, for example, predetermined features from the face image of the user included in the image data and associates the extracted features with the identification information of the user. Further, when the authentication has been successful, the authentication apparatus supplies the identification information of the user associated with the received image data to the information control apparatus 10.

Next, the information control apparatus 10 determines whether or not the authentication has been successful (Step S13). Whether or not the authentication has been successful is determined, for example, by a signal sent from the authentication apparatus. When, for example, the signal indicating that the authentication has been successful is not acquired from the authentication apparatus within a predetermined period after a request signal for performing authentication has been transmitted, the information control apparatus 10 does not determine that the authentication has been successful (Step S13: NO). In this case, the information control apparatus 10 ends the processing.

On the other hand, when, for example, the signal indicating that the authentication has been successful has been acquired from the authentication apparatus within a predetermined period after the request signal for performing authentication has been transmitted, the information control apparatus 10 determines that the authentication has been successful (Step S13: YES). In this case, the information control apparatus 10 acquires the insurance information of the user related to the successful authentication from the storage apparatus (Step S14). Next, the information control apparatus 10 outputs the acquired insurance information to the terminal apparatus (Step S15).

Next, the information control apparatus 10 determines whether or not the certification information has been acquired from the medical institution (Step S16). As described in the description regarding FIG. 1, the certificate information from the medical institution is supplied, for example, from the terminal apparatus. Note that the certificate information may be supplied from an apparatus other than the aforementioned terminal apparatus as long as it is supplied from a medical institution. When it is not determined that the certificate information has been acquired from the medical institution (Step S16: NO), the information control apparatus 10 ends the processing. On the other hand, when it is determined that the certificate information has been acquired from the medical institution (Step S16: YES), the application unit 115 transmits the certificate information to the insurance agency (Step S17) and ends the processing.

The information control apparatus 10 according to the first example embodiment has been described above. Note that the information control apparatus 10 includes, as components that are not shown, a processor and a storage apparatus. The storage apparatus included in the information control apparatus 10 includes a storage apparatus including a non-volatile memory such as a flash memory or a Solid State Drive (SSD). In this case, the storage apparatus included in the information control apparatus 10, which stores the insurance information, may read the insurance information of the user related to the successful facial authentication from the aforementioned storage apparatus.

The storage apparatus that the information control apparatus 10 includes stores a computer program (hereinafter it may also be simply referred to as a program) for executing the information control method according to this example embodiment. Further, the processor loads a computer program into a memory from a storage apparatus and executes this program.

Each of the components that the information control apparatus 10 includes may be implemented by dedicated hardware. Further, some or all of the components may each be implemented by general-purpose or dedicated circuitry, processor, or a combination of them. They may be configured using a single chip, or a plurality of chips connected through a bus. Some or all of the components of each apparatus may be implemented by a combination of the above-described circuitry, etc. and a program. Further, a Central Processing Unit (CPU), a Graphics Processing Unit (GPU), a field-programmable gate array (FPGA) and so on may be used as a processor.

Further, when some or all of the components of the information control apparatus 10 are implemented by a plurality of information processing apparatuses, circuits, or the like, the plurality of information processing apparatuses, the circuits, or the like may be disposed in one place in a centralized manner or arranged in a distributed manner. For example, the information processing apparatuses, the circuits, and the like may be implemented as a form such as a client-server system, a cloud computing system or the like in which the apparatuses or the like are connected to each other through a communication network. Alternatively, the functions of the information control apparatus 10 may be provided in the form of Software as a Service (SaaS).

The aforementioned information control apparatus 10 outputs the insurance information of the user to the medical institution by performing the facial authentication of the user. This eliminates the need for the user to perform an operation of providing information for the medical institution. Further, even in a case in which the language the user speaks is different from the language spoken by staff members in the medical institution or in a situation in which it is difficult or impossible for the user to communicate with others, the information control apparatus 10 is able to suitably output the insurance information of the user. Further, the information control apparatus 10 performs the facial authentication, and thus outputs information definitely associated with the user himself/herself. It is therefore possible to reduce fraudulent authentication.

Further, the information control apparatus 10 acquires, from the medical institution, certificate information of medical treatment that a user related to the facial authentication has received and provides the acquired certificate information for the provider of the insurance that the user has purchased. Accordingly, the user is able to easily take procedures regarding application of the medical insurance that covers the medical treatment that the user has received. That is, according to this example embodiment, it is possible to provide the information control apparatus, the system, the method, and the program that reduce the burden of the procedures regarding the medical insurance.

### Second Example Embodiment

Next, a second example embodiment will be described. An information control apparatus according to the second example embodiment is different from that of the first example embodiment in that the information control apparatus according to the second example embodiment includes a benefit information acquisition unit and a storage unit.

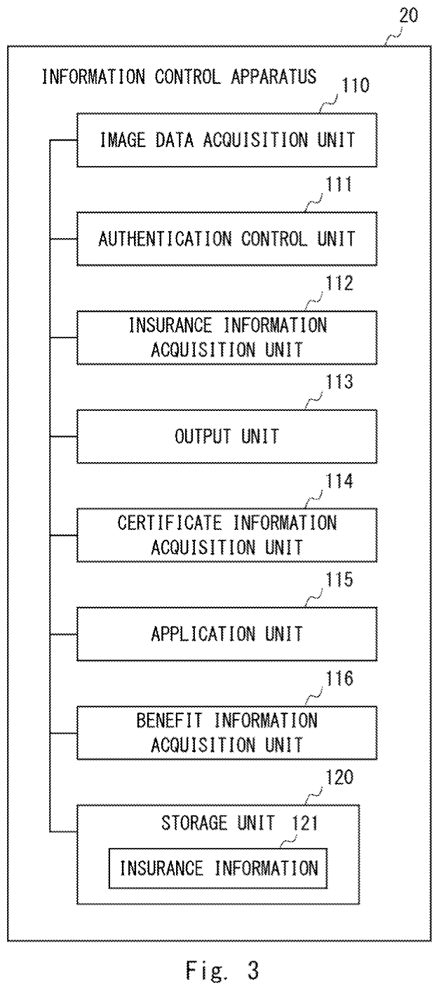

FIG. 3 is a block diagram showing a configuration of the information control apparatus according to the second example embodiment. An information control apparatus 20 shown in FIG. 3 mainly includes an image data acquisition unit 110, an authentication control unit 111, an insurance information acquisition unit 112, an output unit 113, a certificate information acquisition unit 114, an application unit 115, a benefit information acquisition unit 116, and a storage unit 120.

In the information control apparatus 20, the application unit 115 transmits certificate information to an insurance provider with which the user has a contract and transmits a signal for requesting benefit of an insurance money (hereinafter this signal may be referred to as a benefit request signal) to the insurance provider. That is, the information control apparatus 20 according to the second example embodiment requests a response to the benefit request signal for the insurance provider. Note that the application unit 115 may also transmit at least a part of the insurance information stored in the storage unit 120. Accordingly, the information control apparatus 20 is able to transmit the certificate information in association with the insurance information to the insurance provider. The insurance provider compares, when the benefit information is generated, information regarding the insurance that the user has with the certificate information received from the information control apparatus 20. Then, the insurance provider generates the benefit information from the result of the comparison. The insurance provider may compare, when the benefit information is generated, not only the certificate information but also the insurance information transmitted from the application unit 115 with information regarding the insurance that the user has, the information being held by the user.

The benefit information acquisition unit 116 acquires benefit information of the insurance money from the insurance provider as a response to the above benefit request signal. The benefit information of the insurance money includes at least one of a notice regarding whether or not the insurance money can be paid, a notice of withholding of insurance money benefits, an advance notice that the insurance money will be paid, and a notice that the insurance money has been paid. That is, the benefit information acquisition unit 116 acquires, from the insurance provider, information regarding, for example, whether or not the insurance money will be paid for medical treatment that the user has received. The aforementioned benefit information may include information such as the amount of insurance money to be paid, the date of benefit, and the benefit payment method.

The insurance money may be paid to the user or to the medical institution. When the insurance money of the user is paid from the insurance provider to the medical institution, the user pays only the user's share of the cost to the medical institution.

Further, in the information control apparatus 20 shown in FIG. 3, the output unit 113 outputs the above benefit information to the terminal apparatus. Note that the information control apparatus 20 may set the information to be output depending on who manages the terminal apparatus to which the output unit 113 outputs the benefit information. That is, when the terminal apparatus is managed by the medical institution, the information control apparatus 20 outputs the benefit information as a message to the medical institution. On the other hand, when the terminal apparatus is managed by the user, who is the patient, the information control apparatus 20 outputs the benefit information as a message for the user, who is the patient. The output unit 113 may output the benefit information to a plurality of terminal apparatuses. In this case, the output unit 113 may output different messages for each terminal apparatus. That is, the output unit 113 may output, for example, a message to be sent to a medical institution to a terminal apparatus managed by the medical institution, and a message to be sent to the user, who is the patient, to a mobile terminal managed by the user.

The storage unit 120, which is a storage apparatus including a non-volatile memory, stores at least insurance information 121 of the user. Besides the insurance information 121 being associated with identification information on the user, the insurance information 121 may include index information associated with each of the pieces of the insurance information. The index information is associating information for enabling a plurality of pieces of insurance information to be extracted or retrieved for each layer.

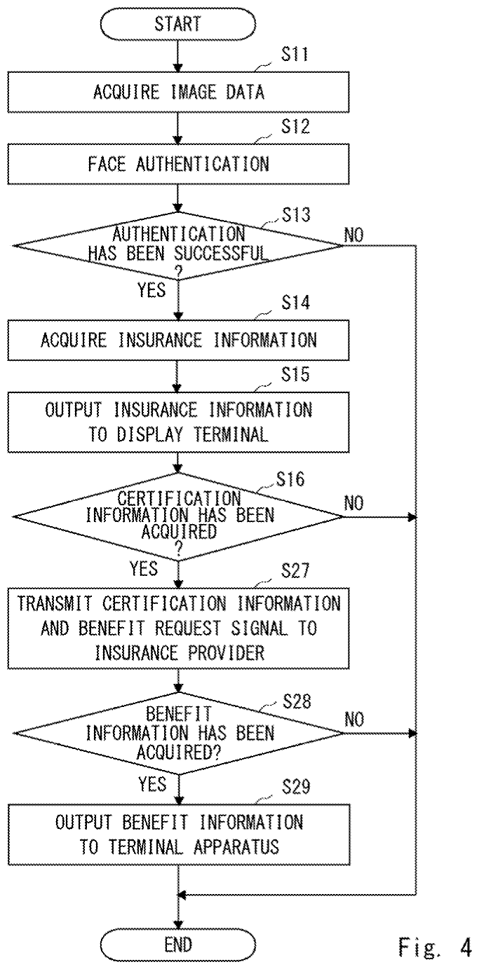

Next, processing performed by the information control apparatus 20 will be described. FIG. 4 is a flowchart showing an example of an information control method according to the second example embodiment. The processing after S16 in the flowchart shown in FIG. 4 is different from that in the flowchart according to the first example embodiment. In the following flowcharts, the description of processing that is similar to that in the aforementioned flowchart will be omitted as appropriate.

When it is determined in Step S16 that the certificate information has been acquired from the medical institution (Step S16: YES), the application unit 115 transmits the certificate information and benefit request signal to an insurance agency (Step S27).

After Step S27, the information control apparatus 20 determines whether or not the benefit information has been acquired from the insurance provider (Step S28). When it is not determined that the benefit information has been acquired from the insurance provider (Step S28: NO), the information control apparatus 20 ends the processing.

On the other hand, when it is determined that the benefit information has been acquired from the insurance provider (Step S28: YES), the output unit 113 of the information control apparatus 20 outputs the acquired benefit information to the terminal apparatus (Step S29) and ends the processing.

The flowchart shown in FIG. 4 has been described above. In the information control method shown in FIG. 4, the image data acquisition unit 110 may acquire administrator information regarding the administrator of the image-capturing apparatus as well, and the insurance information acquisition unit 102 may output the insurance information which is based on the administrator information to the terminal apparatus. In this case, the insurance information acquisition unit 102 may acquire the insurance information of the user related to the facial authentication regardless of the above administrator information, extract the insurance information which is based on the administrator information from the acquired insurance information, and then output the extracted insurance information. Accordingly, the information control apparatus 20 is able to reduce provision of information that is unnecessary for the administrator and to suitably treat information on the user from the viewpoint of protecting privacy.

As described above, according to the second example embodiment, it is possible to provide an information control apparatus, a system, a method, and a program that reduce the burden of taking procedures regarding medical insurance.

### Third Example Embodiment

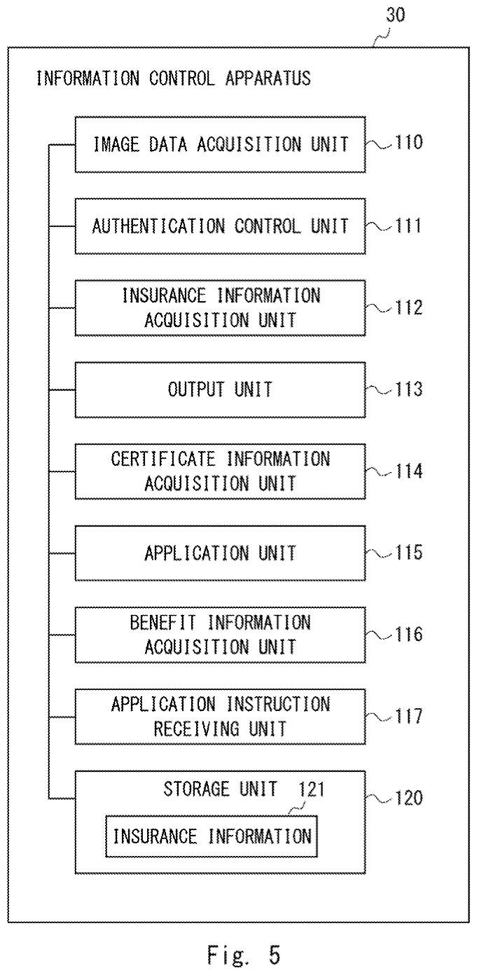

Next, a third example embodiment will be described. An information control apparatus according to the third example embodiment is different from those described in the aforementioned example embodiments in that the information control apparatus according to the third example embodiment includes an application instruction receiving unit. FIG. 5 is a block diagram showing a configuration of the information control apparatus according to the third example embodiment. An information control apparatus 30 shown in FIG. 5 mainly includes an image data acquisition unit 110, an authentication control unit 111, an insurance information acquisition unit 112, an output unit 113, a certificate information acquisition unit 114, an application unit 115, a benefit information acquisition unit 116, an application instruction receiving unit 117, and a storage unit 120.

The application instruction receiving unit 117 receives, from a user, an instruction for transmitting certificate information to the insurance provider. That is, the application instruction receiving unit 117 receives, for example, the above instruction signal from the terminal apparatus related to facial authentication in order to ensure that the user has sent the above instruction. When information regarding medical insurance is treated, it is required that the processing for applying to the insurance provider for insurance money benefit is requested by a user's instruction. In order to meet this requirement, the above instruction is associated with the facial authentication, whereby the information control apparatus 30 recognizes that the instruction has been sent from the user himself/herself, who has purchased the medical insurance.

In this example embodiment, when the information control apparatus 10 has acquired the certificate information from the medical institution and has received an instruction for transmitting the certificate information from the user, the application unit 115 transmits the certificate information to the insurance provider with which the user has a contract.

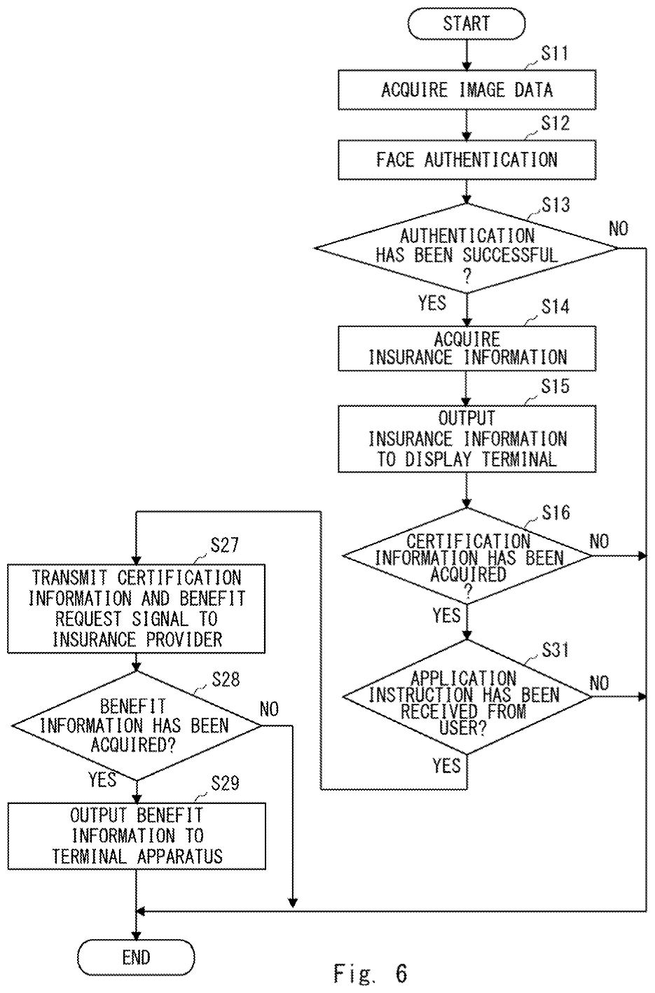

Referring next to FIG. 6, processing executed by the information control apparatus 30 will be described. FIG. 6 is a flowchart showing an information control method according to the third example embodiment. The flowchart shown in FIG. 6 is different from the flowchart according to the second example embodiment shown in FIG. 4 in that Step S31 is provided between Step S16 and Step S27.

When it is determined in Step S16 that the information control apparatus has acquired the certificate information (Step S16: YES), the information control apparatus 30 determines whether or not the application instruction has been received from the user (Step S31). When it is not determined that the application instruction has been received from the user (Step S31: NO), the information control apparatus 30 ends the processing.

On the other hand, when it is determined that the application instruction has been received from the user (Step S31: YES), the information control apparatus 30 transmits the certificate information and the benefit request signal to the insurance provider (Step S27). The following processing is similar to that in the flowchart shown in FIG. 4.

The processing of the information control apparatus 30 according to the third example embodiment has been described above. In the information control apparatus 30, the application unit 115 may notify the insurance provider of account information of the medical institution as well. The account information of the medical institution may be included in the certificate information acquired from the medical institution. By notifying the insurance provider of the account information of the medical institution, the insurance provider is able to perform processing for paying the insurance money to the medical institution. Since the insurance provider pays the insurance money to the medical institution, the user just pays the user's share of the cost of the medical expenses to the medical institution. That is, according to the above configuration, the information control apparatus 30 is able to further reduce the burden on the user of taking the procedures for receiving the medical insurance.

The third example embodiment has been described above. The information control apparatus 30 according to the third example embodiment improves procedural safety by receiving an application instruction sent from a user. Further, the information control apparatus 30 is able to improve the safety and reduce the burden on the user of taking the procedures for receiving the medical insurance by receiving the application instruction from the user related to the facial authentication.

### Fourth Example Embodiment

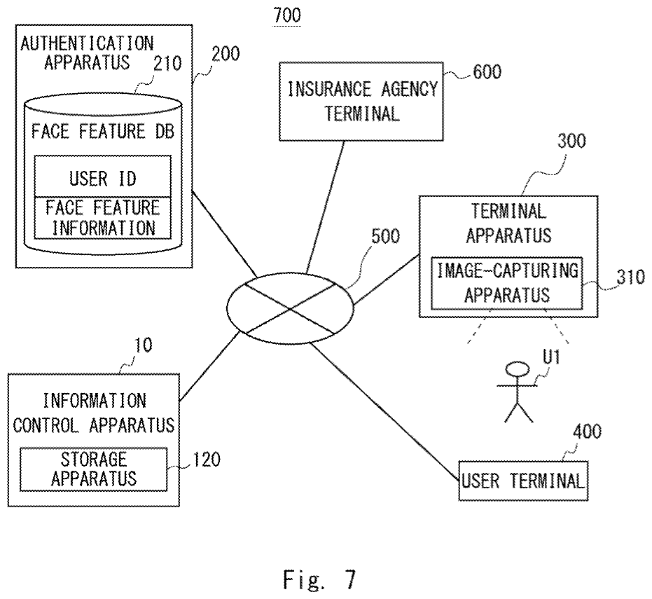

Next, a fourth example embodiment will be described. The fourth example embodiment is an example of a system including the information control apparatus 10 according to the first example embodiment described above. FIG. 7 is a block diagram showing a configuration of an information control system 700 according to the fourth example embodiment. The information control system 700 includes an information control apparatus 10, an authentication apparatus 200, a terminal apparatus 300, a user terminal 400, and an insurance agency terminal 600. The information control apparatus 10, the authentication apparatus 200, the terminal apparatus 300, the user terminal 400, and the insurance agency terminal 600 are connected to one another via a network 500. It is assumed, in this example embodiment, that the information control apparatus 10 includes a storage unit 120. Further, explanations duplicating those of the first example embodiment will be omitted as appropriate.

The information control apparatus 10 is an information processing apparatus for outputting insurance information of a user U1, who is a patient, to the terminal apparatus 300 when authentication regarding a captured image of the user U1 has been successful. The information control apparatus 10 is, for example, a server apparatus achieved by a computer.

The authentication apparatus 200 is an apparatus that performs facial authentication. The authentication apparatus 200 includes a face feature DB 210. The face feature DB 210 is a face feature database that stores a user ID and face feature information of the user in association with each other. The face feature DB 210 is one example of the face feature information storage unit.

The terminal apparatus 300 includes the image-capturing apparatus described in the first example embodiment. The terminal apparatus 300 is installed in a medical institution. The terminal apparatus 300 is an information processing apparatus that shoots the face of the user U1 who has visited the medical institution or the like, transmits a facial authentication request including the captured image to the information control apparatus 10, and receives, when the facial authentication has been successful, the insurance information of the user U1 and displays the received insurance information. The terminal apparatus 300 is operated, for example, by a staff member in the medical institution. Further, the terminal apparatus 300 may be operated, for example, by the user U1. Note that a plurality of terminal apparatuses 300 may be installed in the medical institution. Further, an image-capturing apparatus 310 included in the terminal apparatus 300 may be integrated with the terminal apparatus 300 or may be separated from the terminal apparatus 300.

The user terminal 400 is an information processing apparatus that is operated by the user U1. The user terminal 400 is, for example, a mobile terminal such as a smartphone, a tablet, or a notebook PC that has a communication function. The user terminal 400 may perform processing that is similar to that performed in the terminal apparatus 300 or a part of the processing that is performed in the terminal apparatus 300.

The insurance agency terminal 600 is an information processing apparatus that is managed by an insurance provider. The insurance agency terminal 600 is implemented by a computer including a communication function, a storage apparatus, an arithmetic apparatus and the like. The insurance agency terminal 600 stores information regarding contracts that the insurance provider has with customers.

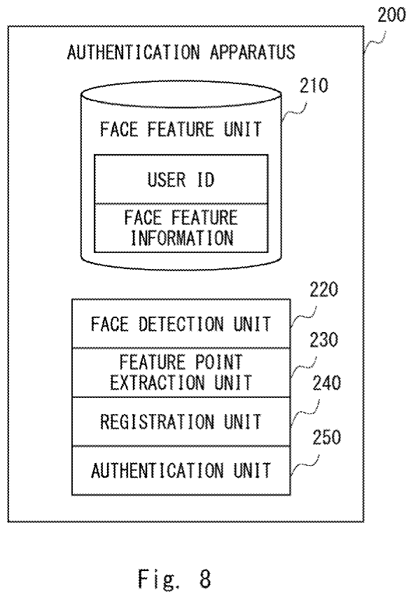

Referring next to FIG. 8, a configuration of the authentication apparatus 200 will be described in detail. FIG. 8 is a block diagram showing a configuration of the authentication apparatus 200. The authentication apparatus 200 includes a face feature DB 210, a face detection unit 220, a feature point extraction unit 230, a registration unit 240, and an authentication unit 250.

The face feature DB 210 is a face feature database that stores the user ID in association with face feature information of the user. The face detection unit 220 detects a face area that the captured image includes and outputs the detected face area to the feature point extraction unit 230. The feature point extraction unit 230 extracts feature points from the face area detected by the face detection unit 220 and outputs the face feature information to the registration unit 240. The face feature information is a set of the extracted feature points.

The registration unit 240 newly issues a user ID when the face feature information is registered. The registration unit 240 registers the issued user ID in association with the face feature information extracted from the registered image in the face feature DB 210. The authentication unit 250 compares the face feature information extracted from the face image with the face feature information in the face feature DB 210. When the two pieces of face feature information coincide with each other, the authentication unit 250 determines that the facial authentication has been successful. On the other hand, when the two pieces of face feature information do not coincide with each other, the authentication unit 250 determines that the facial authentication has failed. The authentication unit 250 sends information indicating whether or not the facial authentication has been successful back to the information control apparatus 10. Whether the two pieces of face feature information coincide with each other corresponds to the result indicating whether the authentication has been successful. Further, when the facial authentication has been successful, the authentication unit 250 specifies the user ID associated with the successful face feature information and sends results of the authentication including the specified user ID and information indicating that the authentication has been successful back to the information control apparatus 10.

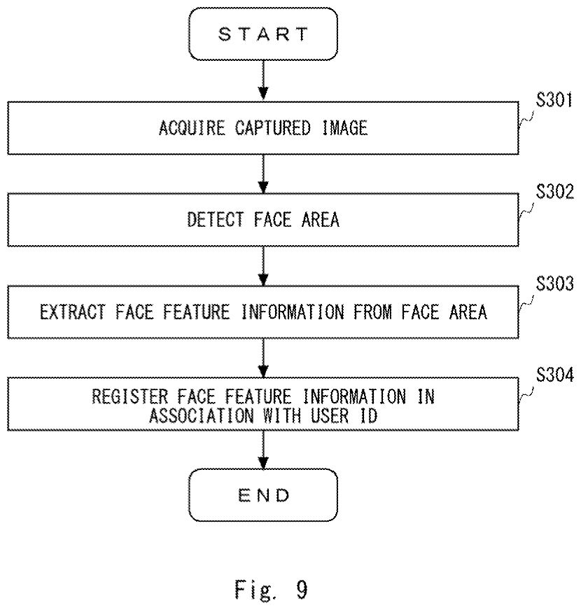

With reference to FIG. 9, an operation of the authentication apparatus 200 when the user ID and the face feature information are registered in the face feature DB 210 will be described. FIG. 9 is a flowchart showing a flow of face feature information registration processing.

When the face feature information is registered, a face information registration terminal (not shown) captures an image including the user's face as an image for registration and sends a face feature information registration request to the authentication apparatus 200 via the network 500. The face information registration terminal is, for example, an information processing apparatus such as a personal computer, a smartphone, or a tablet terminal. The face information registration terminal is, for example, the user terminal 400. The face feature information registration request includes an image for registration. First, the authentication apparatus 200 acquires the image for registration included in the face feature information registration request from the face information registration terminal via the network 500 (Step S301).

Next, the face detection unit 220 detects a face area that the image for registration includes (Step S302) and outputs the detected face area to the feature point extraction unit 230. Next, the feature point extraction unit 230 extracts feature points from the face area and outputs face feature information to the registration unit 240 (Step S303). Next, the registration unit 240 issues a user ID that corresponds to the output face feature information and registers this user ID in association with the face feature information in the face feature DB 210 (Step S304).

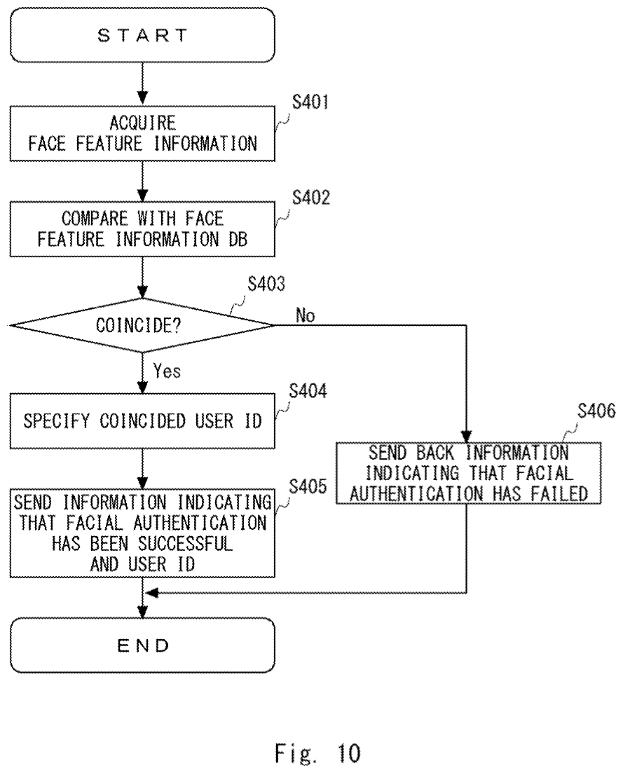

Referring to FIG. 10, an operation of the authentication apparatus 200 when the facial authentication is performed will be described. FIG. 10 is a flowchart showing a flow of facial authentication processing. When the facial authentication is performed, the terminal apparatus 300 captures an image including the user's face as an image for authentication and sends a facial authentication request to the information control apparatus 10 via the network 500. The facial authentication request includes an image for authentication. First, the information control apparatus 10 transmits the face area or the face feature information extracted from the image for authentication to the authentication apparatus 200. The feature point extraction unit 230 extracts the face feature information from the received face area or receives the face feature information, and thus acquires the face feature information (Step S401).

Next, the authentication unit 250 compares the acquired face feature information with the face feature information in the face feature DB 210 (Step S402). When the acquired face feature information coincides with the face feature information in the face feature DB 210 (Step S403: YES), the authentication unit 250 specifies the ID of the user whose face feature information coincides with the face feature information in the face feature DB 210 (Step S404), and sends information indicating that the facial authentication has been successful and the specified user ID back to the information control apparatus 10 (Step S405). When there is no face feature information in the face feature DB 210 that coincides with the face feature information of the user (Step S403: NO), the authentication unit 250 sends information indicating that the facial authentication has failed back to the information control apparatus 10 (Step S406). The authentication apparatus 200 is able to estimate the age and the sex of the user based on the face feature information. It is assumed in Step S406 that the authentication unit 250 sends information including the age and the sex that have been estimated back to the information control apparatus 10.

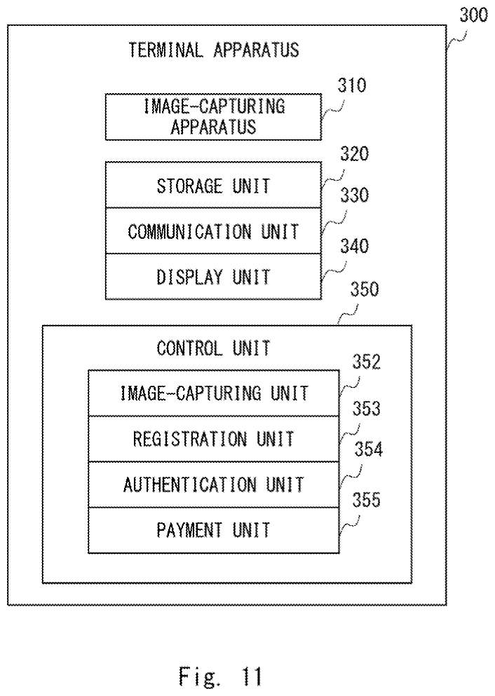

Referring next to FIG. 11, a configuration of the terminal apparatus 300 will be described in detail. The terminal apparatus 300 includes, as hardware components, an image-capturing apparatus such as a camera, a display apparatus, and a computer. The terminal apparatus 300 is an apparatus that sends a facial authentication request by facial authentication. The terminal apparatus 300 is, for example, but not limited to, a terminal that performs payment by facial authentication, a terminal that performs entry control by facial authentication, or digital signage that presents information in accordance with the facial authentication.

FIG. 11 is a block diagram showing the configuration of the terminal apparatus 300. The terminal apparatus 300 includes an image-capturing apparatus 310, a storage unit 320, a communication unit 330, a display unit 340, and a control unit 350. The image-capturing apparatus 310 is an image-capturing apparatus that captures images.

The storage unit 320 is a storage apparatus that stores a program for implementing each of the functions of the terminal apparatus 300. The communication unit 330 is a communication interface with the network 500. The display unit 340 is a display apparatus that displays the results of the facial authentication, information control information and the like for the user. The control unit 350 controls hardware included in the terminal apparatus 300. The control unit 350 includes an image-capturing unit 352, a registration unit 353, an authentication unit 354, and a payment unit 355.

The image-capturing unit 352 sends an image-capturing request to the image-capturing apparatus 310. The image-capturing apparatus 310 captures an image including the user's face. The image captured by the image-capturing apparatus 310 is used as an image for registration and an image for authentication. The registration unit 353 transmits a face feature information registration request to the authentication apparatus 200 via the network 500. The face feature information registration request includes an image for registration captured by the image-capturing apparatus 310. The authentication unit 354 transmits a facial authentication request to the information control apparatus 10 via the network 500. The facial authentication request includes the image for authentication captured by the image-capturing apparatus 310. The authentication unit 354 receives information indicating whether or not the facial authentication has been successful from the information control apparatus 10 and causes the display unit 340 to display the result of the facial authentication.

The payment unit 355 executes payment processing when the facial authentication has been successful. Note that the control unit 350 may include, in place of the payment unit 355, a recording unit (not shown). The recording unit may record the entry and exit by each user into and from the facility in which the terminal apparatus 300 is installed when the facial authentication has been successful. Note that the terminal apparatus 302 shown in FIG. 8 may be the terminal apparatus 300 itself or may be a part other than the image-capturing apparatus 310.

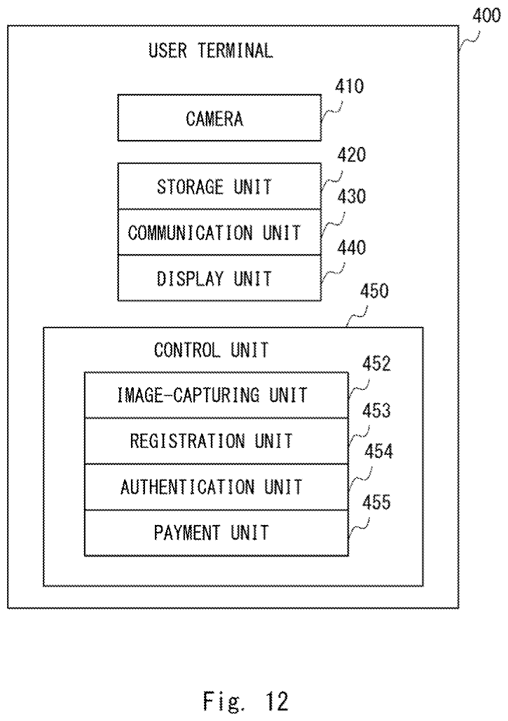

Referring next to FIG. 12, a configuration of the user terminal 400 will be described in detail. FIG. 12 is a block diagram showing a configuration of the user terminal 400. The user terminal 400 includes a camera 410, a storage unit 420, a communication unit 430, a display unit 440, and a control unit 450. The control unit 450 includes an image-capturing unit 452, a registration unit 453, an authentication unit 454, and a payment unit 455. Since the features of the components included in the user terminal 400 are similar to those of the components included in the terminal apparatus 300, the descriptions thereof will be omitted.

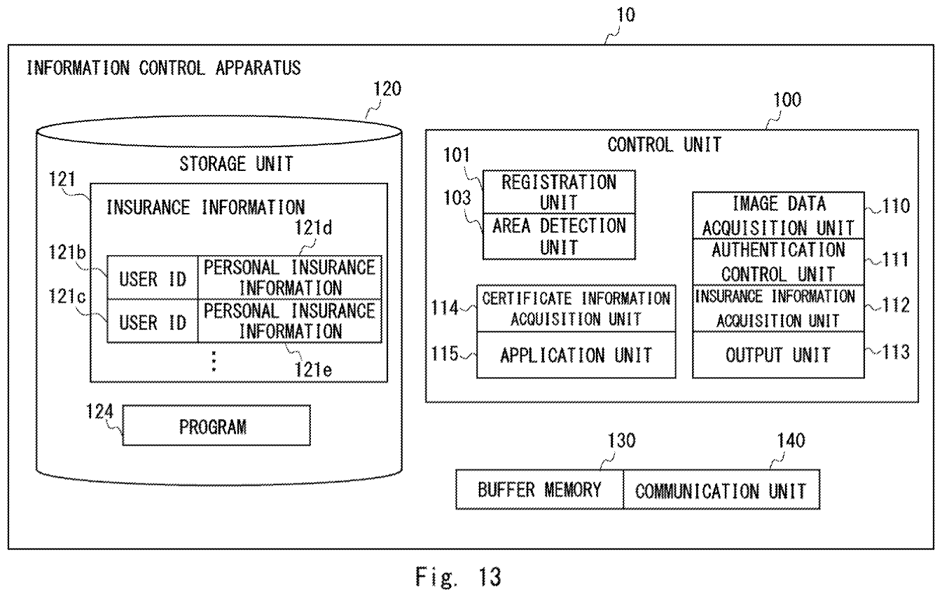

Referring next to FIG. 13, the configuration of the information control apparatus 10 will be described in detail. FIG. 13 is a block diagram showing the configuration of the information control apparatus 10. The information control apparatus 10 includes a control unit 100, a storage unit 120, a buffer memory 130, and a communication unit 140.

The storage unit 120 is a non-volatile storage apparatus that stores at least insurance information 121 and a program 124. The insurance information 121 is a set of user IDs of the respective users and insurance information associated with the respective users. The user ID, which is identification information by which it is possible to identify the user, is, for example, the name, the telephone number, the email address, or any identification number. Personal insurance information 121d and 121e are associated with user IDs 121b and 121c, respectively. That is, the identification information of the plurality of users and personal insurance information of the plurality of respective users are associated with each other in the storage unit 120. The personal insurance information 121d and 121e are, for example, but not limited to, the sex, the age, hobbies, or physical information. The program 124 is a computer program in which the information control processing according to this example embodiment is implemented.

The buffer memory 130, which is a storage area that temporarily stores the content of processing of the control unit 100, is, for example, a volatile storage apparatus such as a Random Access Memory (RAM). The communication unit 140 is an interface that performs communication between the information control apparatus 10 and an external apparatus or the like.

The control unit 100 includes a registration unit 101, an area detection unit 103, an image data acquisition unit 110, an authentication control unit 111, an insurance information acquisition unit 112, an output unit 113, a certificate information acquisition unit 114, and an application unit 115. The control unit 100, which is a control apparatus that controls the operation of the information control apparatus 10, is, for example, a processor such as a CPU. The control unit 100 loads the program 124 into the buffer memory 130 from the storage unit 120 and executes the loaded program. Accordingly, the control unit 100 implements the functions as the registration unit 101, the area detection unit 103, the image data acquisition unit 110, the authentication control unit 111, the insurance information acquisition unit 112, the output unit 113, the certificate information acquisition unit 114, and the application unit 115.

The registration unit 101 receives a registration request from the terminal apparatus 300 or the user terminal 400 via the network 500. The registration unit 101 issues a user ID that corresponds to the user ID included in the received registration request. The registration unit 101 generates the insurance information 121 in which the user ID is associated with personal insurance information that corresponds to each individual user ID, and registers the generated insurance information 121 in the storage unit 120.

The area detection unit 103 detects a face area from the image data. For example, the area detection unit 103 analyzes the image data and recognizes the face area of the user. The authentication control unit 111 causes, when the face area has been specified in the image data, the authentication apparatus 200 to perform facial authentication that uses face feature information for each of the specified face areas.

While the fourth example embodiment has been described above, the information control system 700 according to the fourth example embodiment may configure the information control apparatus 20 or the information control apparatus 30 described above in place of the information control apparatus 10.

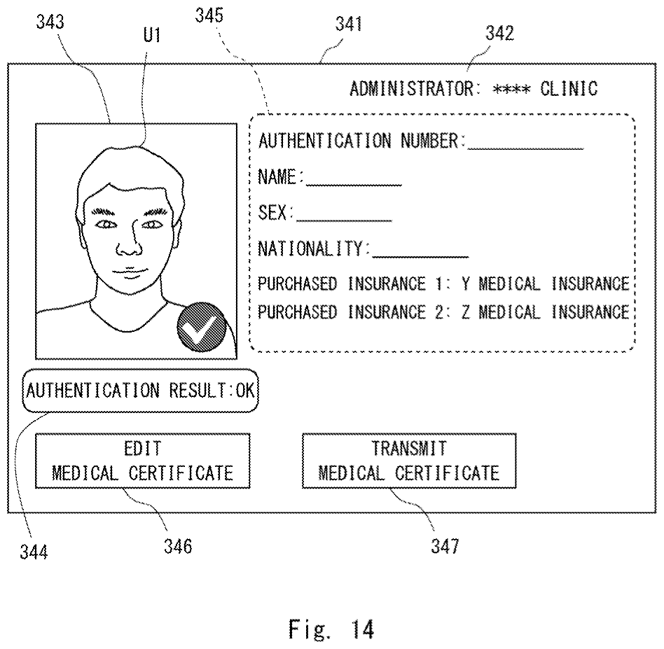

Referring next to FIG. 14, a screen displayed by the display unit 340 of the terminal apparatus 300 will be described. FIG. 14 is a diagram showing an example of the screen displayed on the terminal apparatus. FIG. 14 shows a screen 341 displayed by the display unit 340 of the terminal apparatus 300. The screen 341 includes an information display 342 regarding the administrator, an image 343 related to the facial authentication of the user U1, a display 344 of the result of the facial authentication, an insurance information display 345, a medical certificate edit button 346, and a medical certificate transmission button 347.

In the example shown in FIG. 14, the administrator of the terminal apparatus 300 is a clinic facility called **** clinic. In the **** clinic, the face of the user U1 who has come to the clinic has been taken by the image-capturing apparatus and an operation of requesting insurance information has been performed. The information control apparatus 10 has then caused the authentication apparatus 200 to perform authentication. Further, since the facial authentication has been successful, the information control apparatus 10 has transmitted the insurance information of the user U1 to the terminal apparatus 300.

The insurance information display 345 includes information regarding the authentication number, name, sex, nationality of the user, and the insurance purchased by the user. The authentication number of the user is, for example, unique identification information such as the social insurance number or the like of the user U1 that is given to the user U1. In the column of the insurance purchased by the user included in the insurance information display 345, information “purchased insurance 1: Y life insurance” and “purchased insurance 2: Z life insurance” is shown. That is, the insurance information display 345 shows that the user U1 has purchased two medical insurances.

The medical certificate edit button 346 is a button for creating and editing a medical certificate regarding the medical treatment that the **** clinic has performed on the user U1. A staff member of the **** clinic presses the medical certificate edit button 346 to create or edit a medical certificate. The medical certificate transmission button 347 is a button for transmitting the medical certificate regarding the medical treatment performed on the user U1 created by the **** clinic to the information control apparatus 10. When the staff member of the **** clinic presses the medical certificate transmission button 347, the certificate information is transmitted to the information control apparatus 10. Note that the medical certificate created for the Y medical insurance may be the same as that created for the Z medical insurance or they may be created separately.

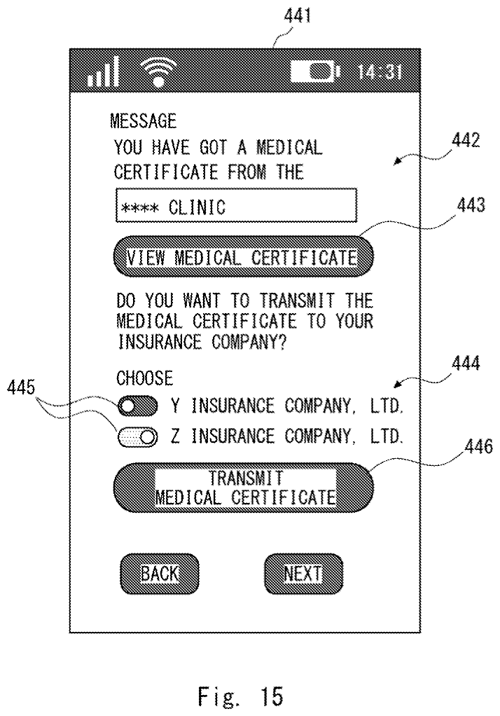

Referring next to FIG. 15, a display example of the user terminal will be described. FIG. 15 is a diagram showing the display example of the user terminal. A display 441 of the user terminal 400 shown in FIG. 15 displays a certificate information acquisition display 442 and an application operation display 444.

A message “You have got a medical certificate from the **** clinic” and a viewing button 443 displayed as “view the medical certificate” are arranged in the certificate information acquisition display 442. The user U1 is able to recognize, by the certificate information acquisition display 442, that the information control apparatus 10 has acquired the certificate information from the **** clinic, which is the medical institution. Further, the user U1 is able to view the medical certificate by pressing the viewing button 443.

The application operation display 444 displays a message “Do you want to transmit the medical certificate to your insurance company?” and a selection button 445 for selecting one of Y Insurance Company, Ltd. and Z Insurance Company, Ltd. Further, a transmission button 446 displayed as “transmit the medical certificate” is arranged in the application operation display 444. The user U1 is able to select an insurance provider to which the certificate information is transmitted by the application operation display 444 and perform an operation of transmitting the certificate information to the selected insurance provider. The user U1 presses the transmission button 446, which causes the information control apparatus 10 to transmit the certificate information to the selected insurance provider.

If it is defined that one medical insurance plan should be applied to one medical treatment, the information control apparatus 10 is able to set the application operation display 444 in such a way that only one insurance provider or only one medical insurance can be selected. Further, when it is required to transmit certificate information items with different contents to different insurance providers, the application operation display 444 enables the user U1 to view the certificate information items for the respective insurance providers.

The information control system 700 may include an information control apparatus 20 in place of the information control apparatus 10. In this case, the application operation display 444 may include an application instruction button in place of the transmission button 446 or in addition to the transmission button 446. By pushing the application instruction button, the information control apparatus 10 is able to confirm that the user U1 intends to apply to the insurance provider for payment of the insurance money benefit. Further, the information control system 700 may execute processing for guiding the user U1 through the application procedures, except for processing for requesting a medical certificate, or processing for editing or filing an application document used in the above procedures in the aforementioned processing that the user U1 performs to request medical insurance from the insurance provider. By executing the aforementioned processing, the information control system 700 is able to execute all the procedures that the user U1 has to take. Accordingly, the information control system 700 is able to reduce the burden on the user U1 of taking the procedures for receiving the medical insurance.

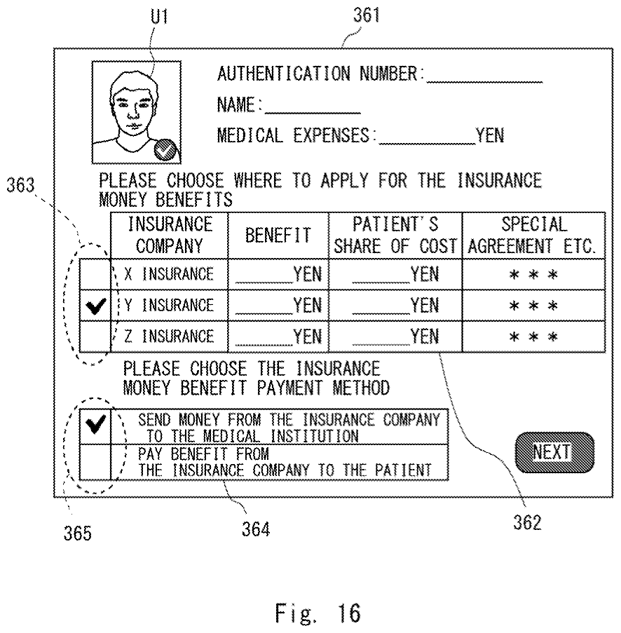

Referring next to FIG. 16, an example of applying for the insurance money benefit will be described. FIG. 16 is a diagram showing an example of an insurance money benefit application screen. A display 361 shown in FIG. 16 may be the display on the terminal apparatus 300 or may be the display on the user terminal 400.

The information related to the authentication of the user U1 and the medical expenses are displayed in the upper part of the display 361. Further, a message “Please choose where to apply for the insurance money benefits” and an insurance provider selection display 362 are displayed at the center of the display 361. The insurance provider selection display 362 shows information for selecting the insurance provider to which the user U1 applies for the insurance money benefits. More specifically, the insurance provider selection display 362 displays, for example, a plurality of insurance companies, which are selection candidates, benefits received from the respective insurance companies, the patient's share of the cost after the patient receives the benefits from each of the insurance companies, and special notes such as those concerning a special agreement.

The insurance provider selection display 362 shown in FIG. 16 shows, as a plurality of insurance companies, “X insurance”, “Y insurance”, and “Z insurance”. Further, the insurance provider selection display 362 displays the benefits from the respective insurance companies, the patient's share of the cost after the patient receives the benefits from each of the insurance companies, and the special agreement of each of the insurance companies. The user U1 is able to select to which insurance provider he/she will apply for insurance benefits by referring to the insurance provider selection display 362. In the insurance provider selection display 362 shown in FIG. 16, the field that corresponds to the Y insurance is checked in a selection field 363. That is, FIG. 16 shows a state in which the user U1 has selected the Y insurance. Note that a plurality of insurance companies may be selected in the selection field 363 in accordance with the insurance system. Alternatively, only one insurance company may be selected in the selection field 363 in accordance with the insurance system.

The order in which the insurance providers shown in the insurance provider selection display 362 are displayed may be changed in accordance with the information for selecting the insurance provider. The insurance providers may be displayed, for example, in an order that descends in accordance with each amount of benefits. Alternatively, the display of the insurance providers may be set, for example, in accordance with the content of each of the special agreements or the like.

A message “Please choose the insurance money benefit payment method” and a benefit payment method selection display 364 are displayed in the lower part of the display 361. The benefit payment method selection display 364 displays benefit payment method options when the user U1 receives the insurance money. The benefit payment method selection display 364 shown in FIG. 16 shows an option “send money from the insurance company to the medical institution” and an option “pay benefit from the insurance company to the patient”.

If the user U1 has selected the item “pay benefit from the insurance company to the medical institution”, the insurance money provided by the insurance provider is sent to the medical institution without involving the user U1. According to this processing, it is sufficient that the user U1 pay the amount of money obtained by subtracting the insurance money from the medical expenses in the medical institution. That is, according to the aforementioned processing, the information control system 700 is able to reduce the burden on the user U1 of taking the procedures for receiving the medical insurance. On the other hand, the user U1 is able to select the item “pay benefit from the insurance company to the patient”. The user U1 may instead receive the insurance money from the insurance provider after he/she pays the medical expenses in the medical institution. In the benefit payment method selection display 364 shown in FIG. 16, the item “pay benefit from the insurance company to the medical institution” is checked in the selection field 365. That is, FIG. 16 shows a state in which the user U1 has selected that the insurance money be sent from the insurance company to the medical institution.

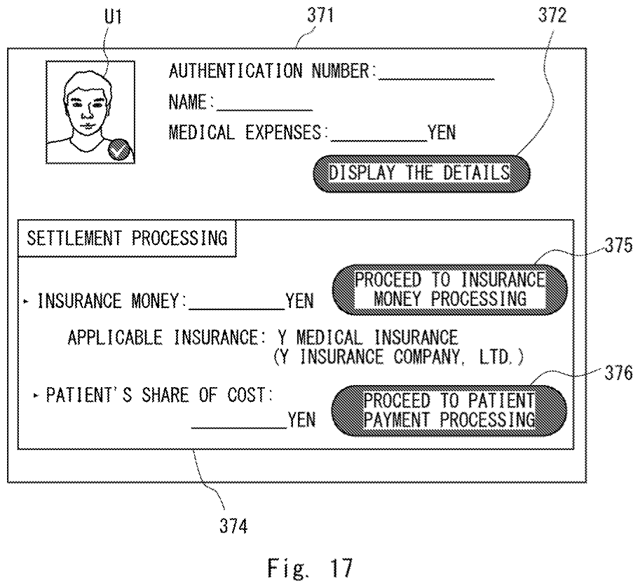

Referring next to FIG. 17, an example of processing for settling the medical expenses will be described. FIG. 17 is a diagram showing an example of a display when the medical expenses are settled. A display 371 shown in FIG. 17 may be the display on the terminal apparatus 300 or may be the display on the user terminal 400.

The information related to the authentication of the user U1 and the medical expenses are displayed in the upper part of the display 371. Further, a button 372 on which “display the details” is indicated is provided near the display of the medical expenses.

A settlement processing display 374 is displayed in the lower part of the display 371. The settlement processing display 374 shows information for paying the aforementioned medical expenses to the medical institution. More specifically, the settlement processing display 374 shows, for example, information regarding the insurance money that the insurance provider pays to the medical institution and information regarding the patient's share that the patient pays to the medical institution.

The settlement processing display 374 shown in FIG. 17 includes the display of the insurance money and the display of the patient charges. The display of the insurance money is accompanied by the display “applicable insurance: Y medical insurance (Y Insurance Company, Ltd.)” as information regarding the insurance for paying the insurance money. That is, the insurance money shown in the settlement processing display 374 is the insurance money that will be paid by the Y insurance selected by the user U1. The patient charges, which correspond to the amount of money obtained by subtracting the above insurance money from the medical expenses, show the amount of money that the user U1 pays to the medical institution.

Further, a button 375 on which “proceed to insurance money processing” is indicated and a button 376 on which “proceed to patient payment processing” is indicated are displayed on the settlement processing display 374. The button 375 is a button for enabling the patient to move to the screen for proceeding with specific processing regarding benefit of the insurance money. The button 376 is a button for enabling the patient to move to the screen for allowing the patient to proceed with specific processing for paying the patient charges to the medical institution.

When the user U1 has selected to receive the insurance money after he/she once pays all the medical expenses, the user U1 can press the button 376 on the settlement processing display 374 so that the screen for proceeding with processing for paying the amount of money that corresponds to the medical expenses is displayed. In this case, the user U1 may proceed with the procedures for receiving the insurance money from the insurance provider on the screen after the button 375 is pressed. In this manner, the information control system 700 is able to execute settlement procedures regardless of whether the insurance money provided from the insurance provider is paid to the medical institution or the insurance money is paid to the user U1.

The fourth example embodiment has been described above. According to the fourth example embodiment, it is possible to provide an information control apparatus, a system, a method, and a program that reduce the burden of taking procedures regarding medical insurance.

The aforementioned program can be stored and provided to a computer using any type of non-transitory computer readable media. Non-transitory computer readable media include any type of tangible storage media. Examples of non-transitory computer readable media include magnetic storage media (e.g., flexible disks, magnetic tapes, hard disk drives), optical magnetic storage media (e.g., magneto-optical disks), CD-Read Only Memory (ROM), CD-R, CD-R/W, semiconductor memories (e.g., a mask ROM, a Programmable ROM (PROM), an Erasable PROM (EPROM), a flash ROM, or a Random Access Memory (RAM)). Further, the program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Note that the present invention is not limited to the aforementioned example embodiments and may be changed as appropriate without departing from the spirit of the present invention.

The whole or part of the example embodiments disclosed above can be described as, but not limited to, the following supplementary notes.

### (Supplementary Note 1)

An information control apparatus comprising:

image data acquisition means for acquiring image data including a face image of a user captured by a predetermined image-capturing apparatus;

authentication control means for causing an authentication apparatus that stores face feature information of the user to perform facial authentication for the image data;

insurance information acquisition means for acquiring, when the facial authentication has been successful, the insurance information related to the facial authentication from a storage apparatus that stores insurance information regarding medical insurance that the user has purchased;

output means for outputting the insurance information to a predetermined terminal apparatus that corresponds to the image-capturing apparatus;

certificate information acquisition means for acquiring, from a medical institution, certificate information of medical treatment that the user has received as a response to the output; and

application means for transmitting, when the certificate information has been acquired from the medical institution, the certificate information to an insurance provider with which the user has a contract.

### (Supplementary Note 2)

The information control apparatus according to Supplementary Note 1, wherein the insurance information acquired by the insurance information acquisition means includes the type of the medical insurance purchased by the user and unique identification information on the user in the medical insurance.

### (Supplementary Note 3)

The information control apparatus according to Supplementary Note 1 or 2, wherein the certificate information acquired by the certificate information acquisition means includes medical institution identification information.

### (Supplementary Note 4)

The information control apparatus according to any one of Supplementary Notes 1 to 3, wherein the certificate information acquired by the certificate information acquisition means includes a medical certificate related to the medical treatment.

### (Supplementary Note 5)

The information control apparatus according to any one of Supplementary Notes 1 to 4, wherein the certificate information acquired by the certificate information acquisition means includes identification information on the user.

### (Supplementary Note 6)

The information control apparatus according to any one of Supplementary Notes 1 to 5, wherein the application means transmits a benefit request signal to the insurance provider.

### (Supplementary Note 7)

The information control apparatus according to Supplementary Note 6, further comprising benefit information acquisition means for acquiring benefit information of the insurance money from the insurance provider as a response to the benefit request signal,

wherein the output means outputs the benefit information to the terminal apparatus.

### (Supplementary Note 8)

The information control apparatus according to Supplementary Note 7, wherein the benefit information acquired by the benefit information acquisition means includes at least one of a notice regarding whether or not the insurance money can be paid, an advance notice that the insurance money will be paid, and a notice that the insurance money has been paid.

### (Supplementary Note 9)

The information control apparatus according to any one of Supplementary Notes 1 to 8, wherein the application means notifies the insurance provider of, besides the certificate information, account information of a medical institution.

### (Supplementary Note 10)

The information control apparatus according to any one of Supplementary Notes 1 to 9, further comprising an application instruction receiving unit configured to receive, from the user, an instruction for transmitting the certificate information to the insurance provider.

### (Supplementary Note 11)

The information control apparatus according to Supplementary Note 10, wherein the application instruction receiving unit further receives, when there are a plurality of the insurance providers to which the certificate information can be transmitted, an instruction related to a selection of the insurance provider from the user.

### (Supplementary Note 12)

The information control apparatus according to Supplementary Note 11, wherein the application instruction receiving unit sets an order in which the insurance providers are displayed based on the information for the selection at the time of the selection of the insurance provider.

### (Supplementary Note 13)

The information control apparatus according to any one of Supplementary Notes 10-12, wherein the application instruction receiving unit further receives an instruction related to a selection of a method for receiving the insurance money from the insurance provider.

### (Supplementary Note 14)

An information control system comprising:

the information control apparatus according to any one of Supplementary Notes 1-13; and

a storage apparatus configured to store the user in association with the insurance information.

### (Supplementary Note 15)

An information control system comprising:

the information control apparatus according to any one of Supplementary Notes 1-13; and

the authentication apparatus that receives the image data from the information control apparatus and performs the facial authentication.

### (Supplementary Note 16)

An information control method, wherein a computer performs the following processing of:

acquiring image data including a face image of a user captured by a predetermined image-capturing apparatus;

causing an authentication apparatus that stores face feature information of the user to perform facial authentication for the image data;

acquiring, when the facial authentication has been successful, the insurance information related to the facial authentication from a storage apparatus that stores insurance information regarding medical insurance that the user has purchased;

outputting the insurance information to a predetermined terminal apparatus that corresponds to the image-capturing apparatus;

acquiring, from a medical institution, certificate information of medical treatment that the user has received as a response to the output; and

transmitting, when the certificate information has been acquired from the medical institution, the certificate information to an insurance provider with which the user has a contract.

### (Supplementary Note 17)

A non-transitory computer readable medium storing an information control program causing a computer to perform the following processing of:

acquiring image data including a face image of a user captured by a predetermined image-capturing apparatus;

causing an authentication apparatus that stores face feature information of the user to perform facial authentication for the image data;

acquiring, when the facial authentication has been successful, the insurance information related to the facial authentication from a storage apparatus that stores insurance information regarding medical insurance that the user has purchased;

outputting the insurance information to a predetermined terminal apparatus that corresponds to the image-capturing apparatus;

acquiring, from a medical institution, certificate information of medical treatment that the user has received as a response to the output; and

transmitting, when the certificate information has been acquired from the medical institution, the certificate information to an insurance provider with which the user has a contract.

### REFERENCE SIGNS LIST

10 Information Control Apparatus
20 Information Control Apparatus
30 Information Control Apparatus
101 Registration Unit
103 Area Detection Unit
110 Image Data Acquisition Unit
111 Authentication Control Unit
112 Insurance Information Acquisition Unit
113 Output Unit
114 Certificate Information Acquisition Unit
115 Application Unit
116 Benefit Information Acquisition Unit
117 Application Instruction Receiving Unit
120 Storage Unit
121 Insurance Information
130 Buffer Memory
140 Communication Unit
200 Authentication Apparatus
210 Face Feature DB
220 Face Detection Unit
230 Feature Point Extraction Unit
240 Registration Unit
250 Authentication Unit
300 Terminal Apparatus
310 Image-capturing Apparatus
320 Storage Unit
330 Communication Unit
340 Display Unit
350 Control Unit
400 User Terminal
410 Camera
420 Storage Unit
430 Communication Unit
440 Display Unit
500 Network
600 Insurance Agency Terminal
700 Information Control System

What is claimed is:

1. An information control apparatus comprising:
at least one memory storing instructions, and
at least one processor configured to execute the instructions to;
acquire image data including a face image of a user captured by a predetermined image-capturing apparatus;
cause an authentication apparatus that stores face feature information of the user to perform facial authentication for the image data;
acquire, when the facial authentication has been successful, the insurance information related to the facial authentication from a storage apparatus that stores insurance information regarding medical insurance that the user has purchased;
output the insurance information to a predetermined terminal apparatus that corresponds to the image-capturing apparatus;
acquire, from a medical institution, certificate information of medical treatment that the user has received as a response to the output; and
transmit, when the certificate information has been acquired from the medical institution, the certificate information to an insurance provider with which the user has a contract.

2. The information control apparatus according to claim 1, wherein the insurance information acquired by at least one processor includes the type of the medical insurance purchased by the user and unique identification information on the user in the medical insurance.

3. The information control apparatus according to claim 1, wherein the certificate information acquired by at least one processor includes medical institution identification information.

4. The information control apparatus according to claim 1, wherein the certificate information acquired by at least one processor includes a medical certificate related to the medical treatment.

5. The information control apparatus according to claim 1, wherein the certificate information acquired by at least one processor includes identification information on the user.

6. The information control apparatus according to claim 1, wherein
the at least one processor is further configured to execute the instruction to transmit a benefit request signal to the insurance provider.

7. The information control apparatus according to claim 6, wherein
the at least one processor is further configured to execute the instructions to acquire benefit information of the insurance money from the insurance provider as a response to the benefit request signal, and
output the benefit information to the terminal apparatus.

8. The information control apparatus according to claim 7, wherein the benefit information acquired by at least one processor includes at least one of a notice regarding whether or not the insurance money can be paid, an advance notice that the insurance money will be paid, and a notice that the insurance money has been paid.

9. The information control apparatus according to claim 1, wherein
the at least one processor is further configured to execute the instruction to notify the insurance provider of, besides the certificate information, account information of a medical institution.

10. The information control apparatus according to claim 1, wherein
the at least one processor is further configured to execute the instruction to receive, from the user, an instruction for transmitting the certificate information to the insurance provider.

11. The information control apparatus according to claim 10, wherein
the at least one processor is further configured to execute the instruction to receive, when there are a plurality of the insurance providers to which the certificate information can be transmitted, an instruction related to a selection of the insurance provider from the user.

12. The information control apparatus according to claim 11, wherein
the at least one processor is further configured to execute the instruction to set an order in which the insurance providers are displayed based on the information for the selection at the time of the selection of the insurance provider.

13. The information control apparatus according to claim 10, wherein the at least one processor is further configured to execute the instruction to receive an instruction related to a selection of a method for receiving the insurance money from the insurance provider.

14. An information control system comprising:
the information control apparatus according to claim 1; and
a storage apparatus configured to store the user in association with the insurance information.

15. An information control system comprising:
the information control apparatus according to claim 1; and
the authentication apparatus that receives the image data from the information control apparatus and performs the facial authentication.

16. An information control method, wherein a computer performs the following processing of:
acquiring image data including a face image of a user captured by a predetermined image-capturing apparatus;
causing an authentication apparatus that stores face feature information of the user to perform facial authentication for the image data;
acquiring, when the facial authentication has been successful, the insurance information related to the facial authentication from a storage apparatus that stores insurance information regarding medical insurance that the user has purchased;
outputting the insurance information to a predetermined terminal apparatus that corresponds to the image-capturing apparatus;
acquiring, from a medical institution, certificate information of medical treatment that the user has received as a response to the output; and
transmitting, when the certificate information has been acquired from the medical institution, the certificate information to an insurance provider with which the user has a contract.

17. A non-transitory computer readable medium storing an information control program that causes a computer to execute the following processing of
acquiring image data including a face image of a user captured by a predetermined image-capturing apparatus;
causing an authentication apparatus that stores face feature information of the user to perform facial authentication for the image data;
acquiring, when the facial authentication has been successful, the insurance information related to the facial authentication from a storage apparatus that stores insurance information regarding medical insurance that the user has purchased;
outputting the insurance information to a predetermined terminal apparatus that corresponds to the image-capturing apparatus;
acquiring, from a medical institution, certificate information of medical treatment that the user has received as a response to the output; and
transmitting, when the certificate information has been acquired from the medical institution, the certificate information to an insurance provider with which the user has a contract.
